(19) United States
(12) Patent Application Publication
(10) Pub. No.: US 2009/0210125 A1
(43) Pub. Date: Aug. 20, 2009

(54) WATER-COOLED ELECTROMAGNETIC RETARDER, A METHOD OF CONTROLLING SUCH A RETARDER AND A MOTOR VEHICLE COMPRISING SUCH A RETARDER

(75) Inventor: Bruno Dessirier, Saint Germain En Laye (FR)

Correspondence Address: MATTHEW R. JENKINS, ESQ., 2310 FAR HILLS BUILDING, DAYTON, OH, 45419, US

(73) Assignee: TELMA, SAINT-OUEN-L'AUMONE (FR)

(21) Appl. No.: 11/576,298

(22) PCT Filed: Sep. 30, 2005
(86) PCT No.: PCT/FR05/02421

§ 371 Date: Apr. 29, 2009

(30) Foreign Application Priority Data
Sep. 30, 2004 (FR) 04/10363

(51) Int. Cl. G06F 19/00; B60T 5/00; B60Q 9/00

(52) U.S. Cl. 701/70; 340/453

(57) ABSTRACT

The present invention concerns an electromagnetic retarder intended to be used in the field of motor vehicles, in particular in the field of industrial vehicles such as heavy goods lorries, buses and coaches. However, the use of an electromagnetic retarder is not limited to a particular category of motor vehicle classed according to their use or weight. On the contrary, the electromagnetic retarder according to the invention can be used also for vans and other light motor vehicles, as the description will subsequently show. For this reason, the present invention will be described with reference to motor vehicles in general, without distinction.

### FIELD OF THE INVENTION

The present invention concerns a water-cooled electromagnetic retarder, the retarder being intended to be used in a motor vehicle as an auxiliary braking device or as an endurance braking device. The invention also concerns a control method for a water-cooled retarder comprising at least one sensor for collecting information concerning at least one physical quantity of the retarder, as well as a motor vehicle equipped with a water-cooled electromagnetic retarder and enabling the control method to be implemented.

### PRIOR ART

The present invention concerns an electromagnetic retarder intended to be used in the field of motor vehicles, in particular in the field of industrial vehicles such as heavy goods lorries, buses and coaches. However, the use of an electromagnetic retarder is not limited to a particular category of motor vehicle classed according to their use or weight. On the contrary, the electromagnetic retarder according to the invention can be used also for vans and other light motor vehicles, as the description will subsequently show. For this reason, the present invention will be described with reference to motor vehicles in general, without distinction.

In order to retard motor vehicles having great inertia related to their weight and to the speed at which they are moving, it is necessary to use auxiliary braking, which is at the same time an endurance braking device, since conventional braking with the service brake of the vehicles, using brake shoes or pads rubbing against a disc of a wheel hub, is not always sufficient to provide the slowing down or even braking of these vehicles in a sure manner.

This is because, the friction of the service brakes being at the basis of the their functioning, the security of the braking depends on the efficacy of the friction, for example shoes against the disc. In addition, since friction generates heat, and an excessively high heating of the shoes and disc reduces the efficacy of the braking, the use of the service brake is excluded whenever endurance braking is necessary, for example on a road sloping downwards. In addition to this restriction, very frequent use of the service brake gives rise to a fairly great consumption of brake pads and maintenance hours for replacing the worn pads.

Unlike friction brakes, electromagnetic retarders, used typically as auxiliary and endurance braking devices, are components almost without wear. This is because their design and operation are based on the principle of eddy currents, an electromagnetic phenomenon requiring the absence of physical contact and therefore friction on the parts involved.

Thus an electromagnetic retarder like the one described in the documents FR-2.440.110 and FR-2.577.357, comprises at least one stator and at least one rotor. The rotor is assembled on a shaft so as to have an external cylindrical face close to an internal cylindrical face of the stator and with a thin air gap interposed between the rotor and stator. The rotor and stator are mounted coaxially. According to the model of electromagnetic retarder chosen, it is either the rotor or the stator that comprises an even number of coils of electric wires with alternating polarity and able to generate a magnetic field in a ferromagnetic part of the stator, when the rotor is inducing, and vice versa.

In order to obtain the typical functioning of an electromagnetic retarder, the stator comprises a field winding formed by coils of electric wires, able to generate a magnetic field in a ferromagnetic piece of the rotor constituting the armature. When the rotor is rotated, the metal pieces on the rotor cut induction lines of the magnetic field generated by the coils of the field winding. As a result induced currents arise in the ferromagnetic piece, referred to as eddy currents. These induced currents, because of a small electrical resistance that is offered to them in this ferromagnetic piece, have appreciable intensity and, according to Lenz's law, a direction such that they oppose, through their effects, the cause that gives them the direction, namely the rotation movement of the rotor. The greater the magnetic field generated by the coils of the field winding, the stronger also are the induced currents and for their part generate a stronger reverse magnetic field, opposing the magnetic field generated by the coils of the field windings and having the effect of retarding and finally braking the rotor more rapidly.

The creation of the eddy currents being accompanied by a heating of the rotor by Joule effect, from which a loss of energy results, it is necessary in general to cool the electromagnetic retarder by means of a gaseous or liquid fluid. In the case of cooling by air, the retarder comprises a fan and in the case of cooling by a liquid fluid, for example water, the retarder comprises a cooling jacket, commonly referred to as a water jacket or water box.

The document EP 311,559 describes by way of example a water-cooled electromagnetic retarder in which the rotor, driven by the transmission shaft, constitutes the field winding and the stator subjected to the induced currents is surrounded by a water box intended to cool it.

Hereinafter, the electromagnetic retarder of the invention will be explained in relation to a motor vehicle for which it constitutes an auxiliary and endurance braking device. However, the general explanations and the description of the embodiments of an electromagnetic retarder of the invention can be transposed by analogy to other applications, for example to the application of an electromagnetic retarder on a test bench for motors or rotary machines where the braking energy employed by the retarder is adjustable and constitutes a measurement for the power of the motor. This is because the rating of the retarder can be varied and adjusted very easily whilst the inertia of a rotating mass, driven by the motor under test, is not.

As is clear from the above description of the operating principle of an electromagnetic retarder, an electromagnetic retarder is a machine that converts the kinetic energy due to the rotation of the transmission shaft into heat. However, the performance of the retarder depends directly on its ability to dissipate the heat. This is because the performance of each of the components making up the retarder is inversely proportional to its temperature. It is therefore important to control the temperature, and in general terms also the other physical quantities, in order to optimise the performance of the retarder.

Currently electromagnetic retarders are not provided with means for constantly monitoring the change in a few physical characteristics such as their temperature, nor means for knowing at any time the state of the retarder and its braking potential.

### OBJECT OF THE INVENTION

The aim of the invention is to remedy these drawbacks and, at the same time, to propose a solution also if possible allowing the integration of the monitoring of an electromagnetic retarder into an automatic system controlling the functioning of a motor vehicle or a test bench equipped with a retarder. In the case of a vehicle equipped with a retarder, it would then be desirable to be able to integrate the monitoring of the retarder into the speed regulation and active safety system of the vehicle.

The aim of the invention is achieved with a water-cooled electromagnetic retarder, comprising at least one sensor for collecting information concerning at least one physical quantity of the retarder, the sensor or sensors being intended to be connected to an information processing device able to generate, on the basis of the information processed, control signals for acting on components controlling the functioning of the retarder.

The invention therefore uses an information processing device provided with several signal inputs and outputs intended respectively to receive information consisting of results of measurement of one or more physical quantities of the retarder and to send control signals intended for components controlling the functioning of the retarder and, where appropriate, the functioning of the vehicle. The measurements of the physical quantities are made by means of sensors disposed at suitable points in the retarder and, where applicable, in the surroundings of the retarder. The information processing device can be mounted directly on the retarder or at a distance with respect to the retarder, for example on the chassis or the driver's cab of the vehicle equipped with the retarder.

Advantageously, the information processing device is arranged so as to be able, from these same signal inputs and outputs, not only to control the retarder but also to communicate with entities of the vehicle external to the retarder. To make this external communication possible, the information is processed according to the criteria of a predefined dialogue protocol of the CAN (Controller Area Network) type or of the K, LIN or other type, according to the requirements of the vehicle manufacturer. By virtue of this standardised processing, the information processing device prepares the control signals in a form that makes it possible to use them at the same time as useful information for other control units of the motor vehicle. Thus the information processing device of the retarder can participate in a dialogue with the other units and exchange information on the state of the retarder, on the state of the vehicle and even on the interconnection with active safety systems of the ABS type (the antilocking system for the wheels). The preparation of the standardised information also enables this information to be displayed in the driver's cab of the vehicle and enables commands and instructions to be entered and introduced by the driver of the vehicle by means of a touch screen.

Communication of the information concerning the state of the retarder, and also communication of the information on the state of the vehicle, in particular on its speed and on the engine speed, then makes it possible to control, better than previously, at any given time, the total braking power of the vehicle according to the current potential of the retarder and possibly also according to the potential predictable for a limited time after the given moment. And this is valid both during the use of the retarder and outside this.

This is because the total braking power of the vehicle corresponds, at a given moment, to the sum of the braking power of the service brakes and of the momentary braking power of the retarder. Whereas the braking power of the service brakes may be considered, in the context of the present invention, to be constant, for the time that these brakes are not faulty, the braking power of the retarder, that is to say its available torque, may vary very greatly, in particular according to its general temperature and/or the temperature of certain components of the retarder. This variation in the available torque of the retarder may be considered to be the resultant of the two thermal effects that occur in the retarder, namely heating during functioning and cooling during and after the functioning of the retarder.

Moreover, even when the retarder is not used, it is nevertheless exposed to the operating conditions of the motor vehicle, in particular with regard to the surrounding temperature and the temperature of the cooling water. This may have a particular influence on the rate of cooling of the retarder after long-term action on the retarder. It may then be particularly advantageous for the driver of the vehicle not only to be able to be assured of the braking capacity of the retarder at the time that he wishes to use it but also to obtain a kind of prediction, over a length of time to be determined, on the change in the torque that will be available during this period of time. It goes without saying that such a prediction could be only indicative, if only because it is subject to the condition of the absence of a further use of the retarder.

When the retarder functions, the taking account of the various physical quantities both of the retarder and its surroundings, by the information processing device, makes it possible to regulate and optimise the functioning of the retarder according to predetermined instructions and/or instructions particularly introduced into the system during the use of the vehicle. It is moreover even conceivable to provide for the information processing device to generate control signals intended to activate and then deactivate, a supplementary cooling circuit for cooling the retarder more quickly. Finally, this variant embodiment of the retarder of the invention and of its control method can be broadened to the possibility of activation of the supplementary cooling circuit by the driver of the vehicle with a view to imminent use of the retarder approaching a road sloping downwards, and deactivation by the information processing device or anticipated activation of the cooling of the single circuit, in order to anticipate a great rise in temperature of the cooling water.

Communicating information in real time therefore makes it possible to transmit, both during and outside phases of use of the retarder, the information and the structures necessary for monitoring the retarder and its functioning and prevention in the event of failure.

An additional possibility of the use of the information consists of the transmission of this to the vehicle speed regulator.

To obtain the various advantages of the invention set out above, the retarder of the invention can have at least one of the following additional characteristics:

the retarder also comprises a sensor for collecting information concerning a physical quantity of the cooling water of the single or main cooling circuit and, where applicable, a sensor for collecting information concerning a physical quantity of the cooling water in a supplementary circuit, the sensor or sensors being intended to be connected to the information processing device; in general, the physical quantity in question is the temperature of the water; however, it could also be a case of the pressure of the water (although going together with the water temperature) since it makes it possible to detect leaks in the cooling circuit

the retarder comprises a device for processing information coming from the sensor or sensors and instruction information coming from the cab of a motor vehicle equipped with a retarder, and a device for generating control signals intended for components controlling the functioning of the retarder;

the retarder comprises connection means for connecting the retarder to a device for processing information coming from the sensor or sensors and a device for generating and sending control signals intended for components controlling the functioning of the retarder;

the retarder comprises a device for regulating the retarding power, the device being intended to be connected to the information processing device;

the retarder comprises a regulation box with means participating in the regulation of the retarding power and means participating in the transmission and/or processing of information supplied by the sensor or sensors;

the retarder comprises a computer for calculating, from the information obtained by the sensor or sensors, the retarding torque available from the retarder or any other physical quantities useful for the functioning of the retarder;

the retarder comprises communication means enabling the retarder to be integrated in a local data communication network of the vehicle, in order to establish an exchange of information between the various components of the vehicle acting during the use of the vehicle;

the retarder comprises a power variator for regulating the power or torque in steps of 0, 25%, 50%, 75% and 100% of the maximum capacity; however, regulation according to other steps or control without steps, in particular a linear control, are also possible.

The aim of the invention is also achieved with a control method for a water-cooled retarder comprising at least one sensor for collecting information concerning at least one physical quantity of the retarder. This method comprises at least the following steps:

measuring at least one physical quantity of the retarder, the result or results of the measurement constituting information,

sending the information to an information processing device,

generating, by means of the information processing device, on the basis of the information processed, control signals for acting on components controlling the functioning of the retarder,

sending the control signals to the control components concerned.

According to the embodiment chosen, the method can also comprise at least one of the following steps:

a step of displaying at least some of the information collected, on a display means situated in the cab of a motor vehicle equipped with the retarder;

a step of calculating the available torque of the retarder and a step of displaying the result of the calculation on a display means situated in the cab of a motor vehicle equipped with the retarder;

a step of calculating the available torque of the retarder and a step of sending the results of the calculation to a device for automatically controlling the speed of a motor vehicle equipped with the retarder.

For implementing the control method of the invention, the information processing device comprises a microprocessor, memories, possibly digital or analogue buffers, and communication ports of the CAN type intended for sending control signals to the retarder and sending and receiving signals concerning various characteristics of the use of other components and equipment on the vehicle.

The physical quantities by means of which the state of the retarder must be monitored in real time are preferably the temperature of the coils, both those of the generator and those of the retarder, as well as the temperature of the water in the cooling circuit, the temperature of the environment close to the retarder and the temperature of the gearbox normally disposed close to the retarder.

The information processing device in general comprises a so-called control part, as well as a so-called power part. Whereas the so-called control part makes it possible to manage the measurements of the various physical quantities, communication with the on-board system of the vehicle and control of the retarder, the so-called power part enables the retarder to be supplied with power according to the requirements of a given moment.

The aim of the invention is also achieved with a motor vehicle equipped with a retarder of the invention having the characteristics described above and which,

when the motor vehicle comprises a means of displaying alphanumeric and/or graphical information, is connected to the display means so that at least information concerning the braking torque available can be displayed thereon;

when the motor vehicle comprises a means of receiving and processing information and a means of generating and sending control signals making it possible to send control signals resulting from the use of the information, to components controlling the speed of the vehicle, is connected to means of receiving and processing information so as to be able to send to it information coming from the retarder and to the means of generating and sending control signals so as to be able to receive therefrom control signals resulting from the use of the information;

when the motor vehicle comprises a communication network and communication means allowing an exchange of information, by means of the communication network, between various components of the vehicle intended to cooperate in the control of the speed of the vehicle, is connected to the communication network so as to allow an exchange of information and control signals between the retarder and the components cooperating in the control of the speed of the vehicle.

For producing an electromagnetic retarder according to the invention, and for implementing the control method according to the invention, use is advantageously made of the components normally available for controlling electrical machines and for transmitting signals and control information. The same applies to the sensors, in particular temperature sensors on the retarder, which may be either of PT1000 technology or thermocouples, to cite only common examples.

As is clear from the above general description of the present invention, the object of the latter is not means for a simple activation and deactivation of an electromagnetic retarder but a control of the retarder by virtue of which the efficiency of the retarder is optimised and the reliability of the components increased, whilst offering the possibility of reducing the weight and bulk of the retarder.

The present invention therefore makes it possible to increase the performance of the retarder through a better knowledge of all its parameters and thereby optimisation of the functioning of the retarder according to the work demanded of it during its life.

In summary, the present invention makes it possible to produce a water-cooled electromagnetic retarder conformed so as to be monitored continually, with regard to its braking capacities, and to implement a method of controlling such a retarder, by virtue of a system of controlling the retarder comprising at least:

an electronic box comprising an information processing device and a device for controlling the electrical energy referred to as a power box, where these two boxes can be combined in a single one,

a cluster of cables connecting the box or boxes firstly to the electrical supply of the vehicle and secondly to the retarder for controlling the retarder and for controlling the power,

a set of sensors for taking account of the information concerning the physical quantities of various elements and components of the retarder and concerning its cooling and surroundings,

an interconnection cluster of the CAN type for exchanging information with the on-board system of the vehicle in which the retarder is installed, and

software specifically designed for implementing the control method.

The present invention moreover also makes it possible to implement a system for diagnosing the retarder and integrating a so-called degraded operating mode in the control of the retarder.

This is because continually monitoring the braking capacity of the retarder makes it possible, in the long term, to accumulate a quantity of data on the change in the various physical quantities of the retarder in the course of its life. This cumulative information makes it possible firstly to observe the aging of certain components of the retarder and to provide deadlines for maintenance work or preventive exchanges of parts of the retarder, secondly, this monitoring makes it possible to detect malfunctioning of one or other of the components of the retarder and to change the operating level of the retarder automatically into a degraded mode, when predetermined criteria are reached.

### BRIEF DESCRIPTION OF THE DRAWINGS

Other characteristics and advantages of the present invention will emerge from the following description of a control method according to the invention, this illustrative and in no way limiting description being given with reference to the drawings, in which:

FIG. 1 shows schematically the interconnection between a vehicle equipped with a retarder according to the invention and the retarder itself, and

FIG. 2 shows schematically the main steps of a method of the invention.

### DESCRIPTION OF AN IMPLEMENTATION OF THE METHOD OF THE INVENTION

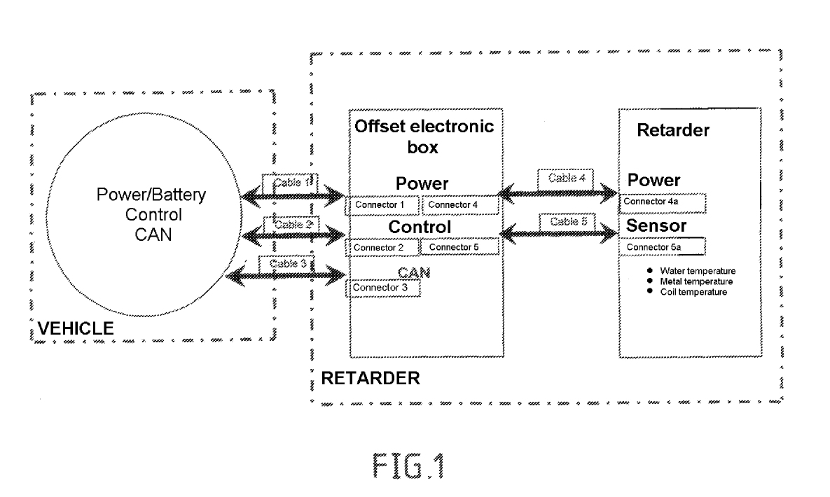

FIG. 1 depicts schematically, in the form of a block layout diagram, the main elements necessary for implementing the method of the invention. The main steps of the method of the invention are, for the record, measuring at least one physical quantity of the retarder, the result or results of the measurement constituting information, the sending of information to an information processing device, the generation of control signals for acting on components controlling the functioning of the retarder, these control signals being generated by the information processing device and on the basis of the information processed by these devices, and the sending of the control signals to the control components concerned.

For implementing these steps and any supplementary and/or alternative steps, it is necessary to integrate, on a motor vehicle intended to be equipped with a retarder according to the invention, means for supplying electrical energy to the retarder in a fairly large quantity, referred to as “the power”, control means and the components of a CAN network. Other elements or components necessary for implementing the method of the invention are disposed in a single electronic box mounted on the retarder or remote from the retarder, or in the form of two complementary electronic boxes, a first one of which comprises connectors and links for the transmission of the electrical energy and the other the control elements for implementing the method, for example for making a measurement, and the means for this purpose, for example a sensor. This box also comprises the components of the CAN network.

The retarder is itself equipped with an interface at which at least some of the cables coming from the sensors arrive.

As for the arrangement of the single electronic box or complementary electronic boxes, it is conceivable for the electronic box to be disposed on the retarder just as it is conceivable that only the first box, referred to as the power box, is disposed on the retarder while the second box, referred to as the control box, is offset from the retarder and is connected to an interface of the retarder by means of cables or that the box or the two boxes are offset from the retarder on the chassis of the vehicle or on any other point thereon according to the recommendations of the manufacturer. The choice of the configuration according to which the single electronic box or one of the two partial boxes is offset from the retarder has the advantage of being able to position the entire electronic box or the corresponding components at an appropriate place.

Thus the single electronic box can be positioned on the chassis of the vehicle not far from the retarder or in any other place on the vehicle according to the installation requirements specific to each vehicle manufacturer. This is because the choice of location of the electronic box on the vehicles can be made according to the space available, but also according to accessibility both for the installation and for the repair of the box or the replacement of cables. Another criterion, finally, is the environment in which the retarder is installed on the vehicle or the environment of the possible places for locating a separate box.

Conversely, the arrangement of all or some of the electronic control components directly on the retarder reduces or avoids interconnection by cables, but adds constraints, in particular thermal, to the elements fixed to the retarder.

With regard to the sensors, FIG. 1 indicates the main physical quantities to be measured. According to this block diagram, it is a case of providing sensors for measuring the temperature of the cooling water for the retarder, the temperature of the retarder casing and the temperature of the retarder coils. Other sensors can be used for measuring the temperature of the board or boards comprising electronic components, and the temperature of the environment in which the offset electronic box is mounted.

This is because, in order to analyse the functioning of the retarder and to deduce therefrom the thermal stresses to be provided for, its possible to allocate the uses of the retarder in two major classes. The first class corresponds to an essentially urban use of the vehicle. This use entails many starts and stops as well as many slowing downs because of the density of traffic and frequent stops at traffic lights or, for example for a bus, frequent stops and starts at bus stops enabling passengers to get on or off.

The second class of use corresponds to an essentially road cycle with a less frequent use on comparison paths, but with much longer durations of slowing and with, possibly, a so-called “speed regulation” operating mode.

According to the first use class, which may easily be imaged by the functioning of a household waste lorry or a town bus, that is to say by vehicles stopping and starting every hundred metres. In this operating mode, the retarder is used to relieve the vehicle service brakes. Consequently the retarder is stressed over short periods but with a relatively high power. This operating mode requires a particularly high cooling capacity. In this case, the control of the retarder according to the method of the invention allows optimisation of the functioning of the retarder and, at the same time, in particular by the display of the available torque of the retarder, on a screen in the vehicle driver's cab, makes it possible to balance the stresses between the retarder and the brakes.

The second operating class of the retarder can easily be imaged by a vehicle travelling on a motorway, where it is exposed rather to predictable retardations spread out over a certain distance, such as the approach to a descending motorway section or the approach to a motorway section with a speed limit. With this functioning, the retarder is used over long periods, but with a lower power than the previous case. Moreover, this operating mode is close to that which is found when the retarder acts in the context of driving at regulated speed, that is to say there are uses of the retarder with moderate power and over longer periods than in urban use.

The control of the retarder can be improved until it almost entirely releases the driver of the vehicle from the management of the operation of the retarder. This is then performed automatically by a central on-board computer cooperating permanently with the information processing device of the electromagnetic retarder. In this case, in controlling the retarder account is continually taken of parameters peculiar to the vehicle, such as the engine speed, the speed of the vehicle, possibly the gearbox ratio, but also taking account of external information such as traffic conditions.

It goes without saying that it is possible, without departing from the principle of the present invention, to adapt the control of the retarder to any method of use other than the two major classes stated above and that it is therefore indeed possible to take account of particular applications defined by a vehicle manufacturer or even according to the recommendations of the user. Such an application may for example be the use of a lightweight vehicle for “all terrain” travel in a mountainous region where the brakes are highly stressed and where it is therefore highly advantageous to be able to use, even on a lightweight vehicle, an electromagnetic retarder.

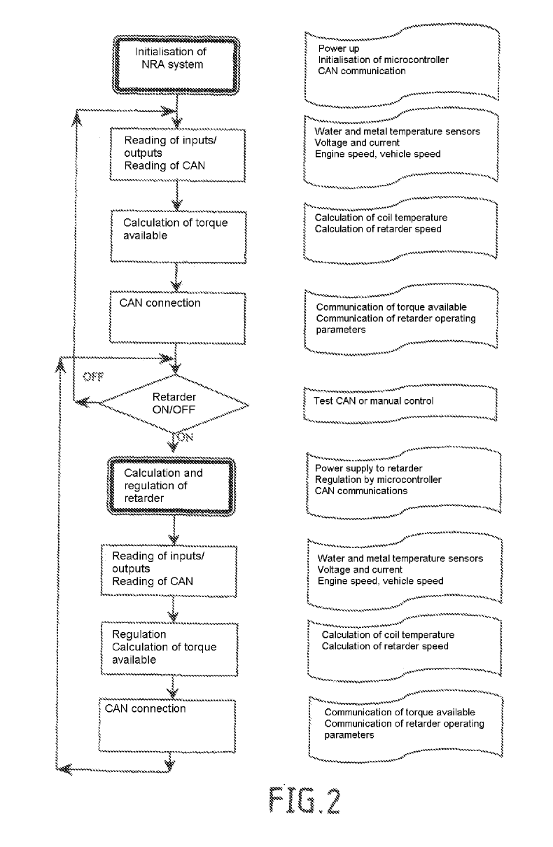

FIG. 2 shows the main steps of the program for automating the management of a retarder according to the invention.

This figure shows in the left-hand part the unfolding of the program with the two possible loops, depending on whether or not the retarder is used, for performing the steps of the program repeatedly according to a predetermined frequency of repetition. The right-hand column gives complementary information on the actions that each of the steps of the program involves. Thus, by way of example, when the retarder system is initialised, there is first of all a powering up of the various components forming this system, and initialisation of the information processing device and in particular of its calculation means, and a communication via the network indicating that the system is ready to function. Next, when the system is functioning, there is a step of reading the values measured by the various sensors, for example the temperature of the cooling water, the temperature of the retarder casing, the measurement of any voltage and current supplied for the functioning of the retarder, the measurement of the engine speed and/or the speed of the vehicle. In the following step, where the available torque of the retarder is calculated, all the data previously entered and read by the information processing device are processed according to a predetermined algorithm. This step is followed by a step of communicating for example the torque available to the network and amongst other things to the driver of the vehicle by means of an alphanumeric screen. The available torque of the retarder can moreover also be displayed graphically.

According to the program depicted in FIG. 2, the following step is an interrogation on the use of the retarder. When the retarder is not being used, the program returns to the step of measuring the various physical quantities. In the contrary case, the program continues with a step of calculation and regulation of the retarder during which the retarder is supplied with electric power, this supply being regulated by a microprocessor according to a table of operating values. In addition, there is communication on the state of the retarder by the network to components involved in the safety of the vehicle such as for example the antilock device.

This step is followed by a step of reading the inputs of values, these values coming from sensors measuring the various physical quantities as in the first loop. The following step comprises the regulation of the retarder and continuous calculation of the torque available. This program terminates on a communication of the available torque by means of the network and communication of other parameters to components for which these parameters are useful.

The program then repeats, in the form of a loop, the question of knowing whether or not the retarder is being used.

1. A water-cooled electromagnetic retarder,
comprising at least one sensor for collecting information concerning at least one physical quantity of the retarder, said at least one sensor being intended to be connected to an information processing device able to generate, on the basis of the information processed, control signals for acting on components controlling the functioning of the retarder.

2. The water-cooled electromagnetic retarder according to claim 1, wherein said water-cooled electromagnetic retarder comprises a sensor for collecting information concerning a physical quantity of the cooling water, said sensor being intended to be connected to said information processing device.

3. The water-cooled electromagnetic retarder according to claim 2, wherein said physical quantity of said cooling water is the temperature.

4. The water-cooled electromagnetic retarder according to claim 1, wherein said water-cooled electromagnetic retarder comprises a device for processing information coming from said at least one sensor and instruction information coming from the cab of a motor vehicle equipped with a retarder, and a device for generating control signals intended for components controlling the functioning of said retarder.

5. The water-cooled electromagnetic retarder according to claim 1, wherein said water-cooled electromagnetic retarder comprises connection means for connecting said retarder to a device for processing information coming from said at least one sensor and a device for generating and sending control signals intended for components controlling the functioning of said retarder.

6. The water-cooled electromagnetic retarder according to claim 1, wherein said water-cooled electromagnetic retarder comprises a device for regulating the retarding power, said device being intended to be connected to said information processing device.

7. The water-cooled electromagnetic retarder according to claim 1, wherein said water-cooled electromagnetic retarder comprises a regulation box with means participating in the regulation of said retarding power and means participating in the transmission and/or processing of information supplied by said at least one sensor.

8. The water-cooled electromagnetic retarder according to claim 1, wherein said water-cooled electromagnetic retarder comprises a computer for calculating, from the information obtained by said at least one sensor, the retarding torque available from said retarder or any other physical quantities useful for the functioning of said retarder.

9. A control method for a water-cooled retarder and comprising at least one sensor for collecting information concerning at least one physical quantity of said retarder, said method comprising the following steps:
measuring at least one physical quantity of said retarder, the result or results of the measurement constituting information,
sending the information to an information processing device,
generating, by means of said information processing device, on the basis of the information processed, control signals for acting on control components controlling the functioning of said retarder,
sending said control signals to said control components concerned.

10. The control method according to claim 9, wherein said method further comprises at least a step of displaying at least some of the information collected, on a display means situated in the cab of a motor vehicle equipped with said retarder.

11. The control method according to claim 9, wherein said method further comprises a step of calculating the available torque of said retarder and a step of displaying the result of the calculation on a display means situated in the cab of a motor vehicle equipped with said retarder.

12. The control method according to claim 9, wherein said method further comprises a step of calculating the available torque of said retarder and a step of sending the results of the calculation to a device for automatically controlling the speed of a motor vehicle equipped with said retarder.

13. A motor vehicle comprising a means of displaying alphanumeric and/or graphical information, wherein said vehicle comprises a retarder according to claim 1, said retarder being connected to the display means so that at least information concerning the braking torque available can be displayed thereon.

14. A motor vehicle comprising means for receiving and processing information and means for generating and sending control signals making it possible to send said control signals resulting from the use of said processing information, to components controlling the speed of said vehicle, wherein said vehicle further comprises a retarder according to claim 1, said retarder being connected to the information reception and processing means so as to be able to send to it information issuing from said retarder and the control signal generation and sending means so as to be able to receive therefrom said control signals resulting from the use of said processing information.

15. A motor vehicle comprising a communication network and communication means allowing an exchange of information, by means of said communication network, between various components of said vehicle intended to cooperate in the control of the speed of said vehicle, wherein said vehicle further comprises a retarder according to claim 1, said retarder being connected to said communication network so as to allow an exchange of information and control signals between said retarder and the components cooperating in the control of the speed of said vehicle.
